(19) United States
(12) Patent Application Publication
(10) Pub. No.: US 2025/0205850 A1
(43) Pub. Date: Jun. 26, 2025

(54) NON-CONTACT PAD CLEANING APPARATUS

(71) Applicant: EBARA CORPORATION, Tokyo (JP)

(72) Inventors: Erina BABA, Tokyo (JP); Nozomu KUWABARA, Tokyo (JP)

(21) Appl. No.: 18/984,570

(22) Filed: Dec. 17, 2024

(30) Foreign Application Priority Data
Dec. 21, 2023 (JP) 2023-215397

(51) Int. Cl. B24B 53/017; B08B 3/02; B08B 3/04; B08B 3/10

(52) U.S. Cl. CPC B24B 53/017; B08B 3/022; B08B 3/024; B08B 3/041; B08B 3/10; B08B 2203/007

(57) ABSTRACT

A non-contact pad cleaning apparatus capable of removing foreign matter from minute holes formed in a polishing surface of a polishing pad is disclosed. The non-contact pad cleaning apparatus includes: a turntable configured to rotate the polishing pad; a plurality of two-fluid nozzles disposed above the polishing pad; and a liquid supply line and a gas supply line coupled to the plurality of two-fluid nozzles. The plurality of two-fluid nozzles are arranged along a radial direction of the polishing pad. The plurality of two-fluid nozzles have outlet ports which are inclined obliquely with respect to a reference line extending in the radial direction of the polishing pad when viewed from a direction perpendicular to the polishing surface of the polishing pad.

### CROSS REFERENCE TO RELATED APPLICATION

This document claims priority to Japanese Patent Application No. 2023-215397 filed Dec. 21, 2023, the entire contents of which are hereby incorporated by reference.

### BACKGROUND

A polishing apparatus is a device for polishing a workpiece, such as wafer, substrate, interconnect panel, used in manufacturing of semiconductor devices. The workpiece is brought into sliding contact with a polishing surface of a polishing pad in the presence of a slurry, so that a surface of the workpiece is polished. In order to maintain the polishing performance of the polishing pad, dressing of the polishing surface of the polishing pad is performed using a dresser. Specifically, the dresser brings its dressing surface, to which abrasive grains (e.g., diamond grains) are fixed, into sliding contact with the polishing surface of the polishing pad, thereby slightly scraping off the polishing surface of the polishing pad, so that the polishing surface of the polishing pad is regenerated.

The polishing surface of the polishing pad has minute holes. Foreign matter, such as polishing debris from the workpiece, abrasive grains contained in the slurry, and debris from the polishing pad, accumulate in these holes. In order to remove the foreign matter from the holes, an atomizer is used to apply a jet of pure water to the polishing surface while the polishing pad is rotating. The foreign matter is washed away from the polishing pad by the pure water.

However, the polishing surface of the polishing pad has a large area. Therefore, the foreign matter once removed from the holes by the jet of pure water may adhere to the polishing surface again. In addition, since the dressing of the polishing pad by the dresser slightly scrapes off the polishing surface of the polishing pad, the foreign matter accumulated in the holes of the polishing pad cannot be completely removed. As a result, the workpiece is polished with the foreign matter remaining on the polishing pad. The foreign matter remaining on the polishing pad causes scratches on the workpiece. In addition, the foreign matter attached to the workpiece may contaminate a cleaning tool used in a cleaning process performed after the polishing process. Furthermore, the foreign matter attached to the workpiece may cause defects in the semiconductor devices.

### SUMMARY

Therefore, there is provided a non-contact pad cleaning apparatus capable of removing foreign matter from minute holes formed in a polishing surface of a polishing pad.

Embodiments, which will be described below, relate to a non-contact pad cleaning apparatus that uses a fluid to clean a polishing surface of a polishing pad used to polish a workpiece, such as wafer, substrate, interconnect panel, etc.

In an embodiment, there is provided a non-contact pad cleaning apparatus for cleaning a polishing surface of a polishing pad in a non-contact manner, the polishing pad being used for polishing a workpiece, comprising: a turntable configured to rotate the polishing pad; a plurality of two-fluid nozzles disposed above the polishing pad; and a liquid supply line and a gas supply line coupled to the plurality of two-fluid nozzles, wherein the plurality of two-fluid nozzles are arranged along a radial direction of the polishing pad, and the plurality of two-fluid nozzles have outlet ports which are inclined obliquely with respect to a reference line extending in the radial direction of the polishing pad when viewed from a direction perpendicular to the polishing surface of the polishing pad.

In an embodiment, the outlet ports of the plurality of two-fluid nozzles are inclined in the same direction as the rotation direction of the polishing pad when viewed from the direction perpendicular to the polishing surface of the polishing pad.

In an embodiment, the outlet ports of the plurality of two-fluid nozzles are located on the reference line when viewed from the direction perpendicular to the polishing surface of the polishing pad.

In an embodiment, inclination angles of the outlet ports of the plurality of two-fluid nozzles with respect to the reference line when viewed from the direction perpendicular to the polishing surface of the polishing pad increase according to a distance of each two-fluid nozzle from a center of the polishing pad.

In an embodiment, distances of the outlet ports of the plurality of two-fluid nozzles from the reference line when viewed from the direction perpendicular to the polishing surface of the polishing pad increase according to the distance of each two-fluid nozzle from the center of the polishing pad, and the distances of the outlet ports of the plurality of two-fluid nozzles from the reference line are distances from the reference line toward a downstream side in a rotation direction of the polishing pad.

In an embodiment, the non-contact pad cleaning apparatus further comprises a fine-bubble generator coupled to the liquid supply line.

In an embodiment, the non-contact pad cleaning apparatus further comprises a liquid heating device coupled to the liquid supply line and configured to heat liquid flowing through the liquid supply line.

In an embodiment, the non-contact pad cleaning apparatus further comprises a pad cleaning nozzle configured to form a jet of liquid-removing fluid to guide liquid contained in a two-fluid on the polishing surface of the polishing pad to a periphery of the polishing pad.

In an embodiment, the non-contact pad cleaning apparatus further comprises: a liquid-removing fluid line configured to supply the liquid-removing fluid to the pad cleaning nozzle; and a fine-bubble generator coupled to the liquid-removing fluid line.

In an embodiment, the pad cleaning nozzle is disposed downstream of the plurality of two-fluid nozzles in a rotation direction of the polishing pad.

In an embodiment, the plurality of two-fluid nozzles include a center-side two-fluid nozzle located at a center side of the polishing pad and a periphery-side two-fluid nozzle located at a periphery side of the polishing pad, and a distance of an outlet port of the periphery-side two-fluid nozzle from the polishing surface is smaller than a distance of an outlet port of the center-side two-fluid nozzle from the polishing surface.

In an embodiment, the plurality of two-fluid nozzles include a center-side two-fluid nozzle located at a center side of the polishing pad and a periphery-side two-fluid nozzle located at a periphery side of the polishing pad, and a distance of an outlet port of the periphery-side two-fluid nozzle from the polishing surface is larger than a distance of an outlet port of the center-side two-fluid nozzle from the polishing surface.

In an embodiment, the liquid supply line has a plurality of branch liquid lines coupled to the plurality of two-fluid nozzles, respectively, the non-contact pad cleaning apparatus further comprises a plurality of liquid flow-rate control valves coupled to the plurality of branch liquid lines, respectively, and an operation controller configured to independently control operations of the plurality of liquid flow-rate control valves, the plurality of two-fluid nozzles include a center-side two-fluid nozzle located at a center side of the polishing pad and a periphery-side two-fluid nozzle located at a periphery side of the polishing pad, and the operation controller is configured to control the operations of the plurality of liquid flow-rate control valves such that a flow rate of liquid supplied to the periphery-side two-fluid nozzle is higher than a flow rate of liquid supplied to the center-side two-fluid nozzle.

In an embodiment, the liquid supply line has a plurality of branch liquid lines coupled to the plurality of two-fluid nozzles, respectively, the non-contact pad cleaning apparatus further comprises a plurality of liquid flow-rate control valves coupled to the plurality of branch liquid lines, respectively, and an operation controller configured to independently control operations of the plurality of liquid flow-rate control valves, the plurality of two-fluid nozzles include a center-side two-fluid nozzle located at a center side of the polishing pad and a periphery-side two-fluid nozzle located at a periphery side of the polishing pad, and the operation controller is configured to control the operations of the plurality of liquid flow-rate control valves such that a flow rate of liquid supplied to the center-side two-fluid nozzle is higher than a flow rate of liquid supplied to the periphery-side two-fluid nozzle.

In an embodiment, the gas supply line has a plurality of branch gas lines coupled to the plurality of two-fluid nozzles, respectively, the non-contact pad cleaning apparatus further comprises a plurality of gas flow-rate control valves coupled to the plurality of branch gas lines, respectively, and an operation controller configured to independently control operations of the plurality of gas flow-rate control valves, the plurality of two-fluid nozzles include a center-side two-fluid nozzle located at a center side of the polishing pad and a periphery-side two-fluid nozzle located at a periphery side of the polishing pad, and the operation controller is configured to control the operations of the plurality of gas flow-rate control valves such that a flow rate of gas supplied to the periphery-side two-fluid nozzle is higher than a flow rate of gas supplied to the center-side two-fluid nozzle.

In an embodiment, the gas supply line has a plurality of branch gas lines coupled to the plurality of two-fluid nozzles, respectively, the non-contact pad cleaning apparatus further comprises a plurality of gas flow-rate control valves coupled to the plurality of branch gas lines, respectively, and an operation controller configured to independently control operations of the plurality of gas flow-rate control valves, the plurality of two-fluid nozzles include a center-side two-fluid nozzle located at a center side of the polishing pad and a periphery-side two-fluid nozzle located at a periphery side of the polishing pad, and the operation controller is configured to control the operations of the plurality of gas flow-rate control valves such that a flow rate of gas supplied to the center-side two-fluid nozzle is higher than a flow rate of gas supplied to the periphery-side two-fluid nozzle.

In an embodiment, the gas supply line has a plurality of branch gas lines coupled to the plurality of two-fluid nozzles, respectively, the non-contact pad cleaning apparatus further comprises a plurality of pressure regulators coupled to the plurality of branch gas lines, respectively, and an operation controller configured to independently control operations of the plurality of pressure regulators, the plurality of two-fluid nozzles include a center-side two-fluid nozzle located at a center side of the polishing pad and a periphery-side two-fluid nozzle located at a periphery side of the polishing pad, and the operation controller is configured to control the operations of the plurality of pressure regulators such that a pressure of gas supplied to the periphery-side two-fluid nozzle is higher than a pressure of gas supplied to the center-side two-fluid nozzle.

In an embodiment, there is provided a non-contact pad cleaning apparatus for cleaning a polishing surface of a polishing pad in a non-contact manner, the polishing pad being used for polishing a workpiece, comprising: a turntable configured to rotate the polishing pad; a two-fluid nozzle disposed above the polishing pad, the two-fluid nozzle having an outlet port facing outward in a radial direction of the polishing pad; a liquid supply line and a gas supply line coupled to the two-fluid nozzle; and a nozzle oscillation mechanism configured to oscillate the two-fluid nozzle along the polishing surface.

In an embodiment, the non-contact pad cleaning apparatus further comprises a fine-bubble generator coupled to the liquid supply line.

In an embodiment, the non-contact pad cleaning apparatus further comprises a liquid heating device coupled to the liquid supply line and configured to heat liquid flowing through the liquid supply line.

In an embodiment, the non-contact pad cleaning apparatus further comprises a pad cleaning nozzle configured to form a jet of liquid-removing fluid to guide liquid contained in a two-fluid on the polishing surface of the polishing pad to a periphery of the polishing pad.

In an embodiment, the non-contact pad cleaning apparatus further comprises: a liquid-removing fluid line configured to supply the liquid-removing fluid to the pad cleaning nozzle; and a fine-bubble generator coupled to the liquid-removing fluid line.

In an embodiment, the pad cleaning nozzle is disposed downstream of the two-fluid nozzle in a rotation direction of the polishing pad.

Since the outlet ports of the two-fluid nozzles are inclined obliquely with respect to the reference line extending in the radial direction of the polishing pad, the two-fluid jets emitted from the outlet ports do not collide with each other and do not hinder the flow of liquid on the polishing surface. The liquid contained in the two-fluid jet flows outward due to the centrifugal force generated by the rotating polishing pad, and can wash away foreign matter, such as polishing debris, from the polishing pad.

Since the outlet ports of the two-fluid nozzles face outward in the radial direction of the polishing pad, the two-fluid jets emitted from the outlet ports form an outward flow of liquid on the polishing surface. This outward flow of liquid is accelerated by the centrifugal force generated by the rotating polishing pad, and can wash away foreign matter, such as polishing debris, from the polishing pad.

### BRIEF DESCRIPTION OF THE DRAWINGS

FIG. 1 is a schematic diagram illustrating an embodiment of a polishing apparatus including a non-contact pad cleaning apparatus;

FIG. 2 is a top view of an embodiment of a plurality of two-fluid nozzles, a plurality of pad cleaning nozzles, and a polishing pad;

FIG. 3 is an enlarged view of the two-fluid nozzles;

FIG. 4 is a diagram illustrating an embodiment of the two-fluid nozzles when emitting two-fluid jets;

FIG. 5 is a diagram for explaining flow of liquid contained in the two-fluid jets discharged from the two-fluid nozzles;

FIG. 6 is a diagram showing another embodiment of an arrangement of the two-fluid nozzles;

FIG. 7 is a diagram for explaining an inclination angle of the two-fluid nozzle with respect to a polishing surface;

FIG. 8 is a diagram showing yet another embodiment of an arrangement of the two-fluid nozzles;

FIG. 9 is a perspective view of the two-fluid nozzles shown in FIG. 8;

FIG. 10 is a diagram for explaining flow of liquid contained in the two-fluid jets discharged from the two-fluid nozzles;

FIG. 11 is a diagram showing yet another embodiment of an arrangement of the two-fluid nozzles;

FIG. 12 is a schematic diagram showing an embodiment of a configuration for supplying liquid and gas to the two-fluid nozzles;

FIG. 13 is a schematic diagram showing another embodiment of a non-contact pad cleaning apparatus;

FIG. 14 is a schematic diagram illustrating an example of an action of fine bubbles;

FIG. 15 is a schematic diagram illustrating another example of the action of fine bubbles;

FIG. 16 is a schematic diagram showing yet another embodiment of a non-contact pad cleaning apparatus;

FIG. 17 is a schematic diagram showing yet another embodiment of a non-contact pad cleaning apparatus;

FIG. 18 is a schematic diagram showing yet another embodiment of a non-contact pad cleaning apparatus.

FIG. 19 is a schematic diagram showing yet another embodiment of a non-contact pad cleaning apparatus;

FIG. 20 is a schematic diagram showing yet another embodiment of a non-contact pad cleaning apparatus;

FIG. 21 is a schematic diagram showing yet another embodiment of a non-contact pad cleaning apparatus;

FIG. 22 is a schematic diagram showing yet another embodiment of a non-contact pad cleaning apparatus;

FIG. 23 is a top view of two-fluid liquid nozzles and pad cleaning nozzles shown in FIG. 22; and

FIG. 24 is a view of the two-fluid nozzle as viewed from a direction indicated by arrow A in FIG. 22.

### DESCRIPTION OF EMBODIMENTS

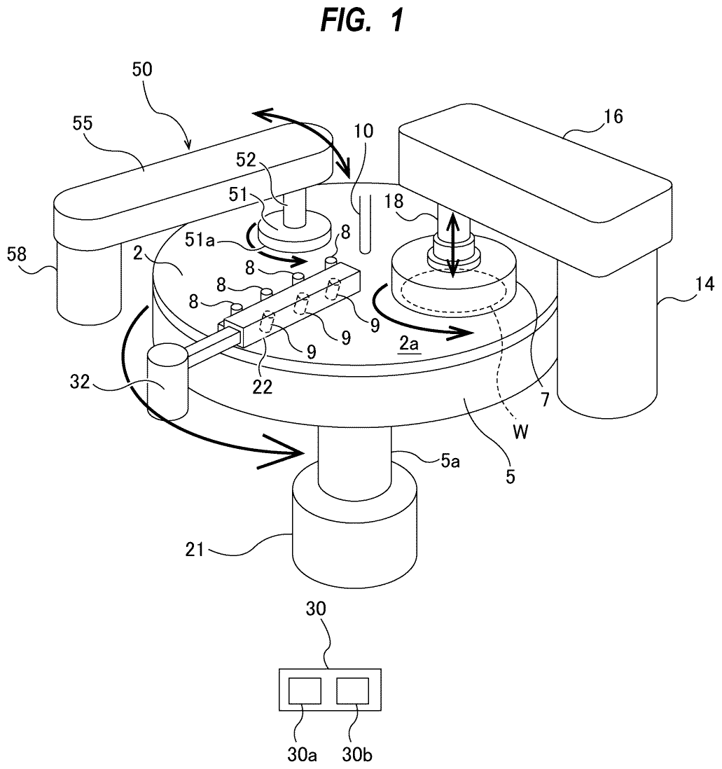

Hereinafter, embodiments will be described with reference to the drawings. FIG. 1 is a schematic diagram showing an embodiment of a polishing apparatus including a non-contact pad cleaning apparatus. The polishing apparatus is a device for chemically and mechanically polishing a wafer W, which is an example of a workpiece used in manufacturing of semiconductor devices. As shown in FIG. 1, this polishing apparatus includes a turntable 5 for supporting a polishing pad 2 having a polishing surface 2a, a polishing head 7 configured to press the wafer W against the polishing surface 2a, a polishing-liquid supply nozzle 10 configured to supply a polishing liquid (e.g., a slurry containing abrasive grains) onto the polishing surface 2a, and a plurality of two-fluid nozzles 8 and a plurality of pad cleaning nozzles 9 configured to clean the polishing surface 2a of the polishing pad 2. The plurality of two-fluid nozzles 8 and the plurality of pad cleaning nozzles 9 are disposed above the polishing surface 2a of the polishing pad 2 and face the polishing surface 2a.

The polishing head 7 is configured to be able to hold the wafer W on its lower surface. The wafer W has a film to be polished. In the following embodiments, a wafer is used as an example of the workpiece, but the workpiece is not limited to a wafer and may be a circular substrate, a quadrilateral substrate, a panel, or the like used in manufacturing of semiconductor devices.

The polishing apparatus further includes a support shaft 14, a polishing-head oscillation arm 16 coupled to an upper end of the support shaft 14, and a polishing-head shaft 18 rotatably supported by a free end of the polishing-head oscillation arm 16. The polishing head 7 is fixed to a lower end of the polishing-head shaft 18. A polishing-head rotating mechanism (not shown) equipped with an electric motor or the like is disposed within the polishing-head oscillation arm 16. This polishing-head rotating mechanism is coupled to the polishing-head shaft 18 and is configured to rotate the polishing-head shaft 18 and the polishing head 7 in a direction indicated by arrow.

The polishing-head shaft 18 is coupled to a polishing-head elevating mechanism (including a ball-screw mechanism, etc.) not shown in the figure. This polishing-head elevating mechanism is configured to move the polishing-head shaft 18 up and down relative to the polishing-head oscillation arm 16. Moving the polishing-head shaft 18 up and down causes the polishing head 7 to move up and down relative to the polishing-head oscillation arm 16 and the turntable 5, as shown by arrows.

The polishing apparatus further includes a table-rotating motor 21 configured to rotate the polishing pad 2 and the turntable 5 about their respective axes. The table-rotating motor 21 is disposed below the turntable 5, and the turntable 5 is coupled to the table-rotating motor 21 via a table shaft 5a. The turntable 5 and the polishing pad 2 are rotated by the table-rotating motor 21 about the table shaft 5a in a direction indicated by arrow. The polishing pad 2 is attached to an upper surface of the turntable 5. An exposed surface of the polishing pad 2 constitutes the polishing surface 2a for polishing the wafer W.

The wafer W is polished as follows. The wafer W, with its surface to be polished facing downward, is held by the polishing head 7. While the polishing head 7 and the turntable 5 are rotated individually, the polishing liquid (e.g., slurry containing abrasive grains) is supplied onto the polishing surface 2a of the polishing pad 2 from the polishing-liquid supply nozzle 10 provided above the turntable 5. The polishing pad 2 is rotated around its central axis together with the turntable 5. The polishing head 7 is moved to a predetermined height by the polishing-head elevating mechanism (not shown). Furthermore, the polishing head 7 presses the wafer W against the polishing surface 2a of the polishing pad 2 while the polishing head 7 is maintained at the above-mentioned predetermined height. The wafer W is rotated together with the polishing head 7. With the polishing liquid present on the polishing surface 2a of the polishing pad 2, the wafer W is brought into sliding contact with the polishing surface 2a. The surface of the wafer W is polished by a combination of a chemical action of the polishing liquid and a mechanical action of the abrasive grains contained in the polishing liquid and/or the polishing pad 2.

The polishing apparatus includes a dresser 50 configured to dress the polishing surface 2a of the polishing pad 2. The dresser 50 includes a dressing disk 51 configured to be brought into sliding contact with the polishing surface 2a of the polishing pad 2, a dresser shaft 52 to which the dressing disk 51 is coupled, and a dresser oscillation arm 55 that rotatably supports the dresser shaft 52. A lower surface of the dressing disk 51 constitutes a dressing surface 51a, which is made of abrasive grains (e.g., diamond particles).

The dresser shaft 52 is coupled to a disk pressing mechanism (including, for example, an air cylinder) (not shown) arranged in the dresser oscillation arm 55. This disk pressing mechanism is configured to press the dressing surface 51a of the dressing disk 51 against the polishing surface 2a of the polishing pad 2 via the dresser shaft 52. Furthermore, the dresser shaft 52 is coupled to a disk rotating mechanism (including, for example, an electric motor) (not shown) arranged in the dresser oscillation arm 55. This disk rotating mechanism is configured to rotate the dressing disk 51 via the dresser shaft 52 in a direction indicated by arrow.

The dressing of the polishing surface 2a of the polishing pad 2 is performed as follows. The polishing pad 2 is rotated together with the turntable 5 by the table rotating motor 21. The dressing disk 51 is rotated around the dresser shaft 52 by the disk rotating mechanism (not shown), while the dressing surface 51a of the dressing disk 51 is pressed against the polishing surface 2a by the disk pressing mechanism (not shown) and is brought into sliding contact with the polishing surface 2a. During the rotation of the dressing disk 51, the dresser oscillation arm 55 is rotated around the support shaft 58 to oscillate the dressing disk 51 in a radial direction of the polishing surface 2a. In this way, the polishing pad 2 is slightly scraped off by the dressing disk 51, and the polishing surface 2a is dressed (regenerated). The dressing of the polishing surface 2a of the polishing pad 2 is performed during or after the polishing of the wafer W.

The multiple two-fluid nozzles 8 are disposed above the polishing pad 2 and are arranged along the radial direction of the polishing pad 2. Each two-fluid nozzle 8 is configured to form a two-fluid jet constituted of a fluid mixture of a liquid and a gas, and to emit the two-fluid jet toward the polishing surface 2a of the polishing pad 2. The multiple two-fluid nozzles 8 and the multiple pad cleaning nozzles 9 are held by a nozzle carrier 22. The nozzle carrier 22 is fixed to a support 32.

The multiple pad cleaning nozzles 9 are arranged along the radial direction of the polishing pad 2. Each pad cleaning nozzles 9 is configured to emit a jet of liquid-removing fluid toward the polishing surface 2a of the polishing pad 2. The multiple pad cleaning nozzles 9 are disposed downstream of the multiple two-fluid nozzles 8 in the rotation direction of the polishing pad 2.

The two-fluid nozzles 8 and the pad cleaning nozzles 9 simultaneously discharge the two-fluid jets and the liquid-removing fluid jets onto the polishing surface 2a of the polishing pad 2 to clean the polishing surface 2a. This cleaning of the polishing surface 2a of the polishing pad 2 is performed after the wafer W is polished and before the next wafer is polished. Cleaning of the polishing pad 2 using the two-fluid nozzles 8 and the pad cleaning nozzles 9 (hereinafter sometimes referred to as pad cleaning operation) may be performed before or after dressing of the polishing pad 2 using the dresser (hereinafter sometimes referred to as dressing operation), or may be performed during the dressing operation.

For example, the dressing operation may be performed after polishing of the wafer W, and then the pad cleaning operation may be performed. In another example, the dressing operation and the pad cleaning operation may be performed simultaneously after polishing of the wafer W. In yet another example, the dressing operation may be performed during polishing of the wafer W, and the pad cleaning operation may be performed after polishing of the wafer W and the dressing operation. A time (or duration) of the pad cleaning operation, i.e., a time (or duration) for cleaning the polishing pad 2 using the two-fluid nozzles 8 and the pad cleaning nozzles 9, may be set arbitrarily.

The polishing apparatus includes an operation controller 30 configured to control operations (including the polishing operation for the wafer W, the dressing operation, and the pad cleaning operation) of the polishing apparatus. The operation controller 30 is composed of at least one computer. The operation controller 30 includes a memory 30a in which programs are stored, and a processor 30b configured to execute arithmetic operations according to instructions included in the programs. The memory 30a includes a main memory, such as a random access memory (RAM), and an auxiliary memory, such as a hard disk drive (HDD) or a solid state drive (SSD). Examples of the processor 30b include a CPU (central processing unit) and a GPU (graphic processing unit). However, the specific configuration of the operation controller 30 is not limited to these examples.

In the embodiment shown in FIG. 1, the non-contact pad cleaning apparatus, which cleans the polishing surface 2a of the polishing pad 2 in a non-contact manner, includes the plurality of two-fluid nozzles 8, the plurality of pad cleaning nozzle 9, and the turntable 5. When a flow rate of the liquid contained in the two-fluid jets discharged from the two-fluid nozzles 8 is sufficiently high, the pad cleaning nozzles 9 may not be provided. The turntable 5 constitutes a part of the non-contact pad cleaning apparatus, and at the same time, the turntable 5 constitutes a part of the polishing apparatus shown in FIG. 1.

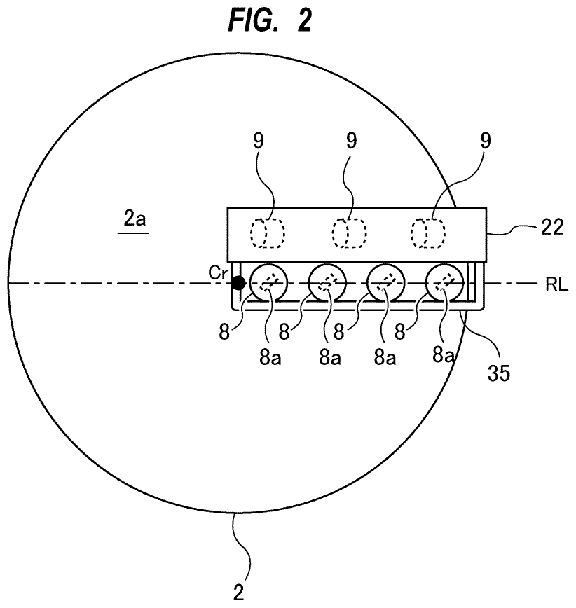

FIG. 2 is a top view of an embodiment of the plurality of two-fluid nozzles 8, the plurality of pad cleaning nozzle 9, and the polishing pad 2. In the embodiment shown in FIG. 2, the polishing pad 2 rotates in the direction indicated by the arrow (counterclockwise in the example of FIG. 2). The plurality of two-fluid nozzles 8 are fixed to the nozzle carrier 22 by a nozzle holder 35. The pad cleaning nozzles 9 are arranged along the radial direction of the polishing pad 2. These pad cleaning nozzles 9 are arranged so as to face in the radially outward direction of the polishing pad 2, and configured to form a flow of liquid-removing fluid in the radially outward direction on the polishing surface 2a of the polishing pad 2.

In the embodiment shown in FIG. 2, four two-fluid nozzles 8 are arranged in the radial direction of the polishing pad 2. However, the number of two-fluid nozzles 8 is not limited to that in this embodiment, and two, three, or five or more two-fluid nozzles 8 may be provided.

In this embodiment, positions of the two-fluid nozzles 8 and positions of the pad cleaning nozzles 9 are fixed and are always located above the polishing pad 2. In an embodiment, the two-fluid nozzles 8 may be arranged away from the pad cleaning nozzles 9. For example, the two-fluid nozzles 8 may be held by a nozzle holder or a nozzle carrier (not shown) that is separated from the pad cleaning nozzles 9. Even in this case, the pad cleaning nozzles 9 are arranged downstream of the two-fluid nozzles 8 in the rotation direction of the polishing pad 2. Each two-fluid nozzle 8 is a fan nozzle configured to form a fan-shaped two-fluid jet. Each two-fluid nozzle 8 has an outlet port 8a at its bottom for emitting the two-fluid jet.

As shown in FIG. 2, when viewed from a direction perpendicular to the polishing surface 2a of the polishing pad 2, the outlet ports 8a of the multiple two-fluid nozzles 8 are inclined obliquely with respect to a reference line RL extending in the radial direction of the polishing pad 2. The reference line RL is an imaginary straight line that passes through a center Cr of the polishing pad 2 and extends in the radial direction of the polishing pad 2. In this embodiment, as viewed from the direction perpendicular to the polishing surface 2a of the polishing pad 2, the outlet ports 8a of the multiple two-fluid nozzles 8 are on the reference line RL.

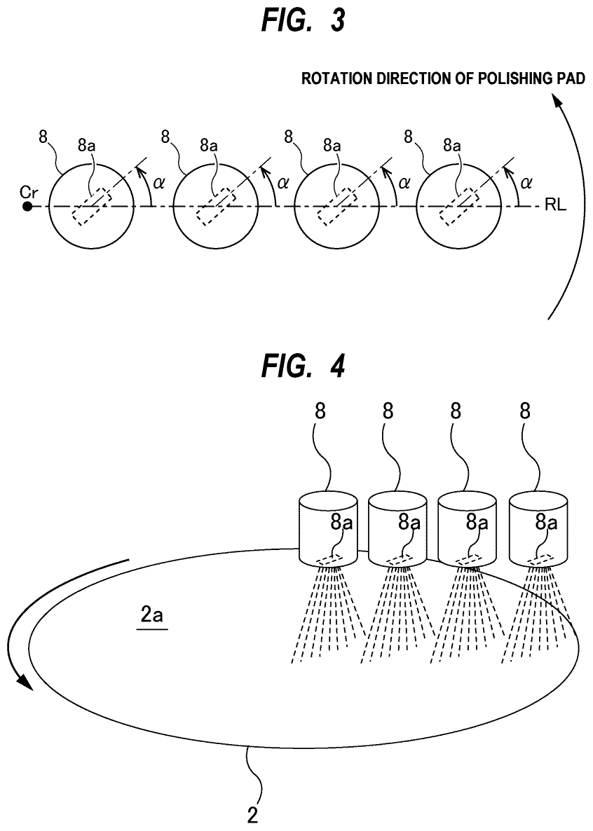

FIG. 3 is an enlarged view of the two-fluid nozzles 8. The outlet port 8a of each two-fluid nozzle 8 is inclined at a predetermined angle α with respect to the reference line RL. More specifically, the outlet port 8a of each two-fluid nozzle 8 is inclined in the same direction as the rotation direction of the polishing pad 2. In the embodiment shown in FIG. 3, since the polishing pad 2 rotates counterclockwise, the outlet port 8a of each two-fluid nozzle 8 is also inclined counterclockwise with respect to the reference line RL when viewed from above. The outlet ports 8a of the four two-fluid nozzles 8 are inclined at the same angle, but may be inclined at different angles. For example, the inclination angles α of the outlet ports 8a of the four two-fluid nozzles 8 with respect to the reference line RL may increase according to a distance of each two-fluid nozzle 8 from the center Cr of the polishing pad 2.

As shown in FIG. 2, the outlet ports 8a of the multiple two-fluid nozzles 8 are arranged at equal intervals from the center Cr to a periphery of the polishing pad 2. Therefore, when the polishing pad 2 is rotating, the two-fluid nozzles 8 can deliver the two-fluid jets onto the entire polishing surface 2a of the polishing pad 2.

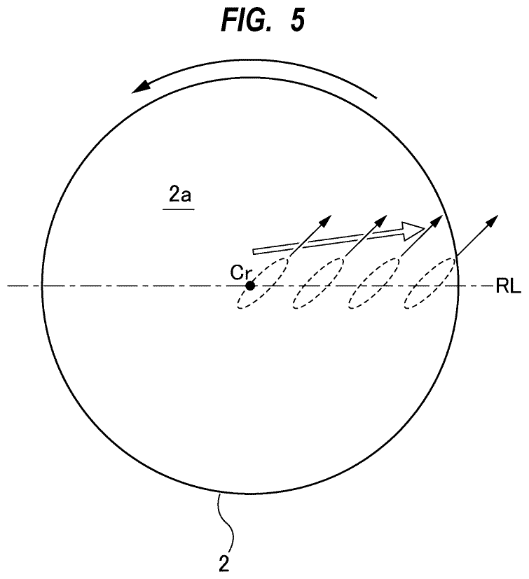

FIG. 4 is a diagram showing an embodiment of the two-fluid nozzles 8 when emitting the two-fluid jets, and FIG. 5 is a diagram explaining flow of liquid contained in the two-fluid jets emitted from the two-fluid nozzles 8. The fan-shaped two-fluid jets emitted from the multiple two-fluid nozzles 8 impinge on the polishing surface 2a of the polishing pad 2 without colliding with each other. Elliptical dotted lines shown in FIG. 5 represent regions where the two-fluid jets impinge on the polishing surface 2a (hereinafter referred to as impingement regions). These impingement regions are inclined obliquely with respect to the reference line RL and are aligned on the reference line RL.

The two-fluid jets can remove foreign matter (e.g., abrasive grains of the slurry, polishing debris, such as reaction by-products generated during polishing of the wafer, and debris of the polishing pad 2 generated during the dressing operation) from minute holes formed in the polishing surface 2a of the polishing pad 2. The liquid contained in the two-fluid jets forms flows of liquid on the polishing surface 2a after the two-fluid jets impinge on the polishing surface 2a of the polishing pad 2. As shown in FIG. 5, the polishing pad 2 rotates in the direction indicated by the arrow, so that the liquid flows toward the outside of the polishing pad 2 and in the rotation direction of the polishing pad 2 due to centrifugal force and friction between the polishing pad 2 and the liquid. Such flows of liquid can wash away the foreign matter that has been discharged from the holes of the polishing pad 2 from the polishing pad 2. Furthermore, flow of the liquid-removing fluid indicated by thick white arrow can enhance the action of discharging the liquid contained in the two-fluid jets and the foreign matter contained in the liquid from the polishing pad 2.

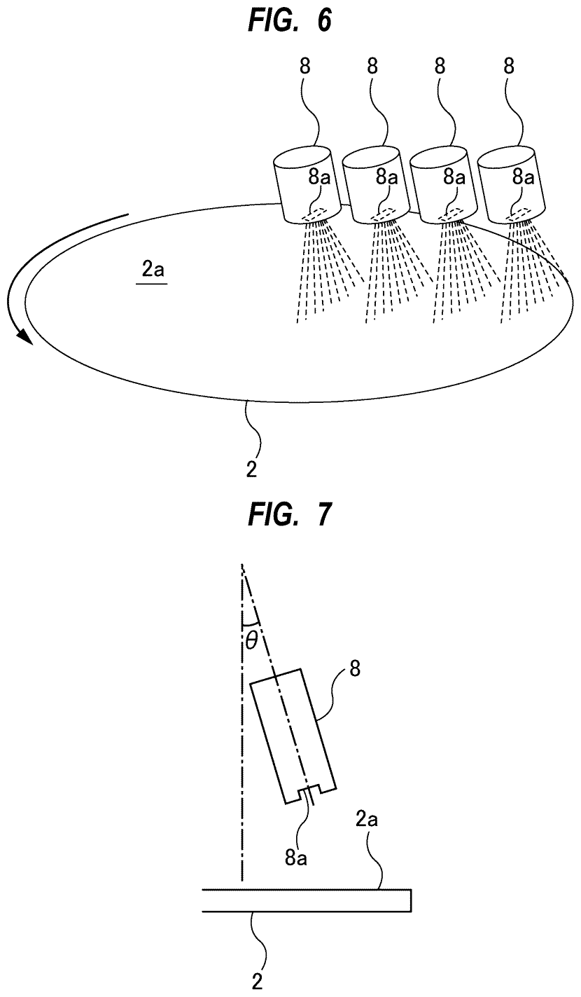

FIG. 6 is a diagram showing another embodiment of an arrangement of the two-fluid nozzles 8. As shown in FIG. 6, each two-fluid nozzle 8 may be inclined with respect to the polishing surface 2a such that the two-fluid jet is emitted in the radially outward direction of the polishing pad 2. Each two-fluid nozzle 8 is inclined such that the outlet port 8a of each two-fluid nozzle 8 faces in the radially outward direction of the polishing pad 2. The two-fluid nozzles 8 can form flow of the liquid that flows radially outward, making it easier to discharge the foreign matter from the polishing pad 2.

FIG. 7 is a diagram for explaining an inclination angle of the two-fluid nozzle 8 with respect to the polishing surface 2a. An inclination angle θ of each two-fluid nozzle 8 with respect to a direction perpendicular to the polishing surface 2a is larger than 0 degrees and is equal to or less than 60 degrees. More preferably, the inclination angle θ of each two-fluid nozzle 8 is within a range of 15 to 30 degrees. The multiple two-fluid nozzles 8 may be inclined with respect to the polishing surface 2a at different angles. In an embodiment, each two-fluid nozzle 8 is inclined with respect to the polishing surface 2a such that the outlet port 8a of each two-fluid nozzle 8 faces in the radially outward direction of the polishing pad 2 and faces downstream in the rotation direction of the polishing pad 2. The two-fluid nozzles 8 can form flow of the liquid flowing radially outward, making it easier to discharge the foreign matter from the polishing pad 2.

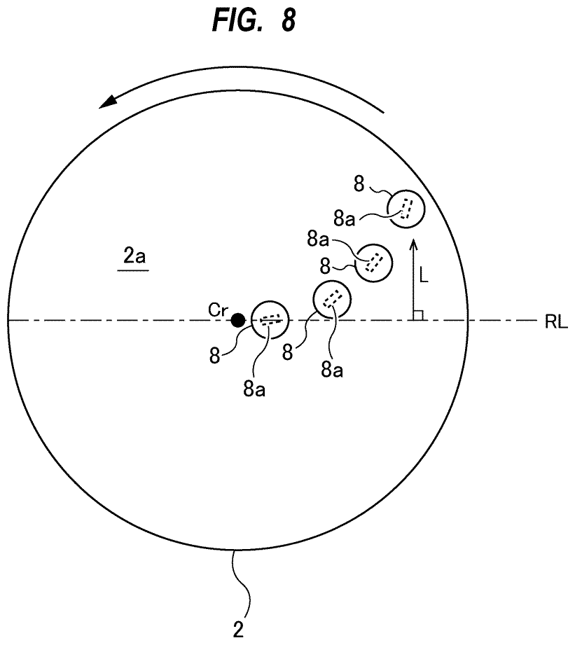

FIG. 8 is a diagram showing yet another embodiment of an arrangement of the two-fluid nozzles 8. In FIG. 8, the pad cleaning nozzles 9, the nozzle carrier 22, and the nozzle holder 35 are not depicted. When viewed from the direction perpendicular to the polishing surface 2a of the polishing pad 2, the inclination angles of the outlet ports 8a of the multiple two-fluid nozzles 8 with respect to the reference line RL increase according to the distance of each two-fluid nozzle 8 from the center Cr of the polishing pad 2. The inclination angle of the outlet ports 8a of each two-fluid nozzle 8 with respect to the reference line RL corresponds to the angle α described with reference to FIG. 3.

In addition, when viewed from the direction perpendicular to the polishing surface 2a of the polishing pad 2, distances L from the reference line RL to the outlet ports 8a of the multiple two-fluid nozzles 8 increase according to the distance of each two-fluid nozzle 8 from the center Cr of the polishing pad 2. The distances L from the reference line RL to the outlet port 8a of each two-fluid nozzle 8 are distances from the reference line RL toward the downstream side in the rotation direction of the polishing pad 2.

Although not shown in the drawings, the multiple two-fluid nozzles 8 may be fixed to the nozzle carrier 22 by the nozzle holder 35 (see FIG. 2), or the pad cleaning nozzles 9 may be provided away from the multiple two-fluid nozzles 8.

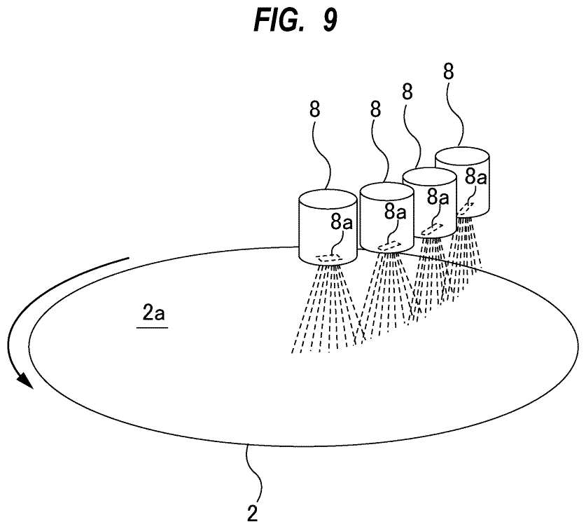

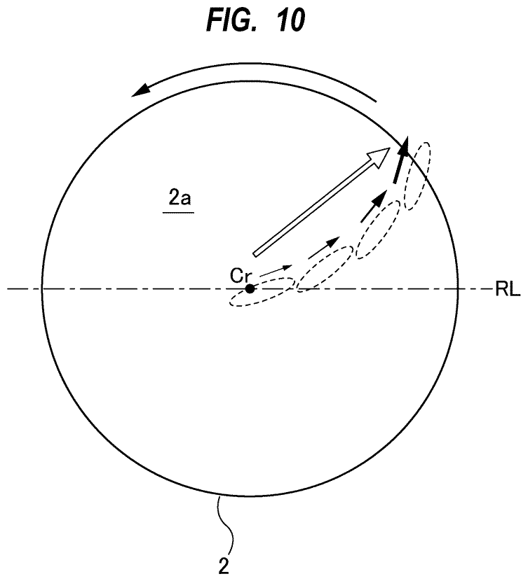

FIG. 9 is a perspective view of the two-fluid nozzles 8 shown in FIG. 8, and FIG. 10 is a diagram illustrating the flow of liquid contained in the two-fluid jets discharged from the two-fluid nozzles 8. The fan-shaped two-fluid jets discharged from the multiple two-fluid nozzles 8 impinge on the polishing surface 2a of the polishing pad 2. Elliptical dotted lines shown in FIG. 10 represent impingement regions where the two-fluid jets impinge on the polishing surface 2a. These impingement regions are inclined obliquely with respect to the reference line RL, and are coupled in an arc extending from the center Cr to the periphery of the polishing pad 2.

The liquid constituting the two-fluid jet discharged from each two-fluid nozzle 8 merges with the liquid constituting the two-fluid jet discharged from the other two-fluid nozzle 8, forming a strong flow of liquid moving from the center Cr toward the periphery of the polishing pad 2. This flow of liquid can wash away the foreign matter that has been discharged from the holes in the polishing pad 2 from the polishing pad 2. Furthermore, the flow of liquid-removing fluid indicated by thick white arrow can enhance the action of discharging the liquid contained in the two-fluid jets and the foreign matter contained in the liquid from the polishing pad 2.

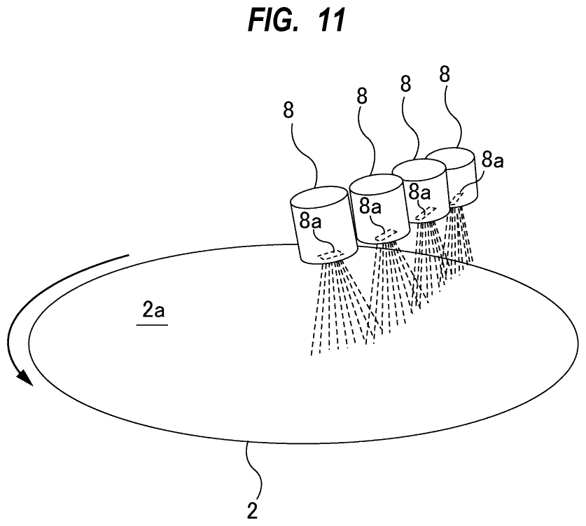

In an embodiment, as shown in FIG. 11, each two-fluid nozzle 8 is inclined with respect to the polishing surface 2a such that the two-fluid jet is emitted in the radially outward direction of the polishing pad 2. The multiple two-fluid nozzles 8 may be inclined with respect to the polishing surface 2a at different angles. Each two-fluid nozzle 8 is inclined such that the outlet port 8a of each two-fluid nozzle 8 faces in the radially outward direction of the polishing pad 2. The inclination angle of each two-fluid nozzle 8 with respect to the direction perpendicular to the polishing surface 2a is larger than 0 degrees and is equal to or less than 60 degrees. More preferably, the inclination angle of each two-fluid nozzle 8 is within a range of 15 to 30 degrees. In an embodiment, each two-fluid nozzle 8 is inclined with respect to the polishing surface 2a such that the outlet port 8a of each two-fluid nozzle 8 faces in the radially outward direction of the polishing pad 2 and faces downstream in the rotation direction of the polishing pad 2. The two-fluid nozzles 8 can form flow of the liquid flowing radially outward, making it easier to discharge the foreign matter from the polishing pad 2.

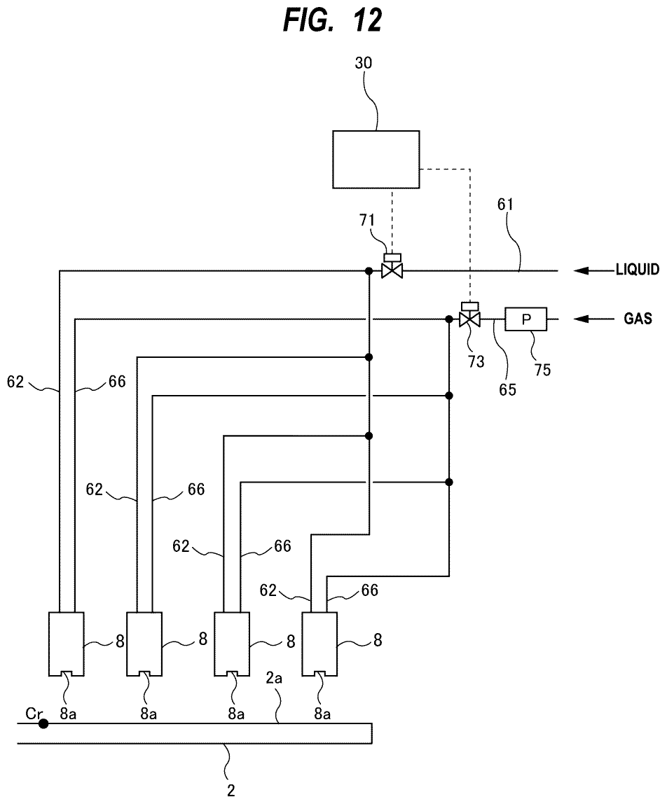

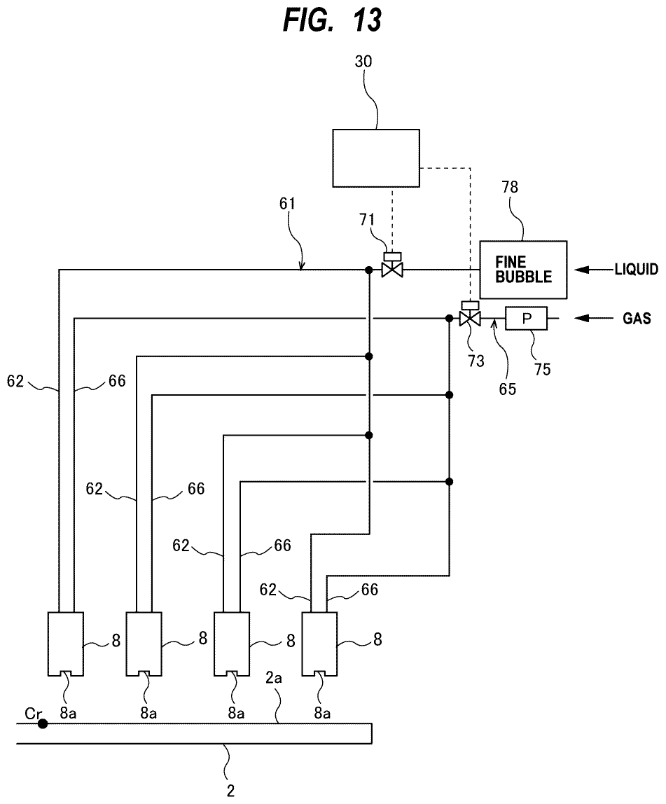

Examples of the liquid supplied to the two-fluid nozzles 8 and the liquid-removing fluid supplied to the pad cleaning nozzles 9 include pure water and pure water containing fine bubbles. Examples of the gas supplied to the two-fluid nozzles 8 include air and inert gas (e.g., nitrogen gas). FIG. 12 is a schematic diagram showing an embodiment of a configuration for supplying the liquid and the gas to the two-fluid nozzles 8. The non-contact pad cleaning apparatus includes a liquid supply line 61 and a gas supply line 65 coupled to the plurality of two-fluid nozzles 8. The liquid supply line 61 is coupled to a liquid supply source (e.g., a pure-water supply source) which is not shown in the drawings, and the gas supply line 65 is coupled to a gas supply source (e.g., an air supply source or an inert-gas supply source) which is not shown in the drawings.

The liquid supply line 61 has a plurality of branch liquid lines 62, and the gas supply line 65 has a plurality of branch gas lines 66. The plurality of two-fluid nozzles 8 are respectively coupled to the plurality of branch liquid lines 62, and further respectively coupled to the plurality of branch gas lines 66.

The non-contact pad cleaning apparatus includes a liquid flow-rate control valve 71 disposed in the liquid supply line 61, and a gas flow-rate control valve 73 and a pressure regulator 75 disposed in the gas supply line 65. The liquid flow-rate control valve 71 is configured to regulate a flow rate of the liquid supplied to the plurality of two-fluid nozzles 8. The gas flow-rate control valve 73 is configured to regulate a flow rate of the gas supplied to the plurality of two-fluid nozzles 8. The pressure regulator 75 is configured to regulate a pressure of the gas supplied to the plurality of two-fluid nozzles 8. The liquid flow-rate control valve 71, the gas flow-rate control valve 73, and the pressure regulator 75 are electrically coupled to the operation controller 30, and operations of the liquid flow-rate control valve 71, the gas flow-rate control valve 73, and the pressure regulator 75 are controlled by the operation controller 30.

The liquid and gas are supplied to each two-fluid nozzle 8 through the liquid supply line 61 and the gas supply line 65, and are mixed in each two-fluid nozzle 8. Then, the fluid mixture of the liquid and the gas is discharged as the two-fluid jet from the outlet port 8a of each two-fluid nozzle 8.

FIG. 13 is a schematic diagram showing another embodiment of the non-contact pad cleaning apparatus. Configurations of this embodiment that are not particularly described are the same as those of the embodiment described with reference to FIG. 12, and repetitive descriptions will be omitted. As shown in FIG. 13, the non-contact pad cleaning apparatus of this embodiment further includes a fine-bubble generator 78 coupled to the liquid supply line 61. The liquid, such as pure water, is first supplied to the fine-bubble generator 78, and the liquid containing fine bubbles is generated by the fine-bubble generator 78. Configuration of the fine-bubble generator 78 is not particularly limited, and a commercially available fine-bubble generator can be used. The liquid containing the fine bubbles is delivered to the two-fluid nozzles 8 through the liquid supply line 61. The two-fluid nozzles 8 emit the two-fluid jets containing the fine bubbles onto the polishing pad 2.

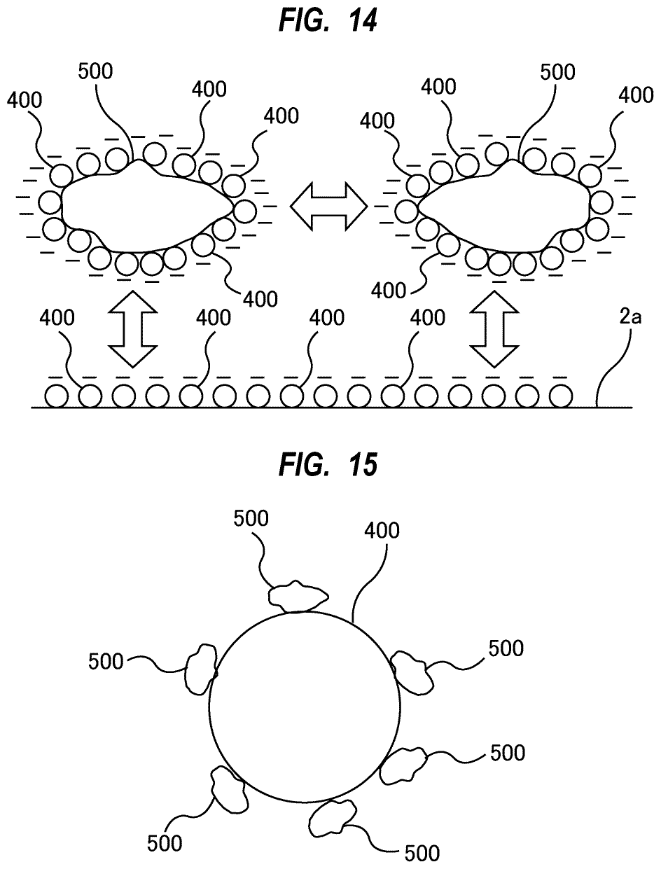

FIG. 14 is a schematic diagram for explaining an example of an action of fine bubbles. Fine bubbles 400 are usually negatively charged. Foreign matter 500, such as polishing debris, is surrounded by the fine bubbles 400 present in the liquid, while the fine bubbles 400 adhere to the polishing surface 2a of the polishing pad 2. The fine bubbles 400 surrounding the foreign matter 500 and the fine bubbles 400 surrounding another foreign matter 500 repel each other due to the negative charge, so that the foreign matters 500 can be prevented from adhering to each other. Furthermore, since the fine bubbles 400 exist on the polishing surface 2a, the fine bubbles 400 surrounding the foreign matter 500 repel the fine bubbles 400 on the polishing surface 2a, so that the foreign matter 500 can be prevented from adhering to the polishing surface 2a again.

FIG. 15 is a schematic diagram for explaining another example of the action of fine bubbles. Microscopic foreign matters 500 adhere to a fine bubble 400, and the foreign matters 500 are discharged from the polishing pad 2 together with the fine bubble 400 by the flow of the liquid.

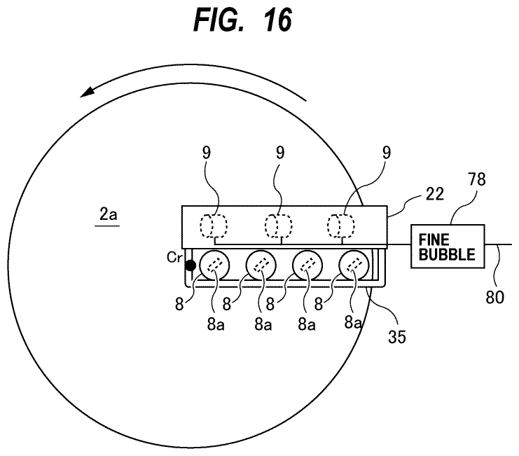

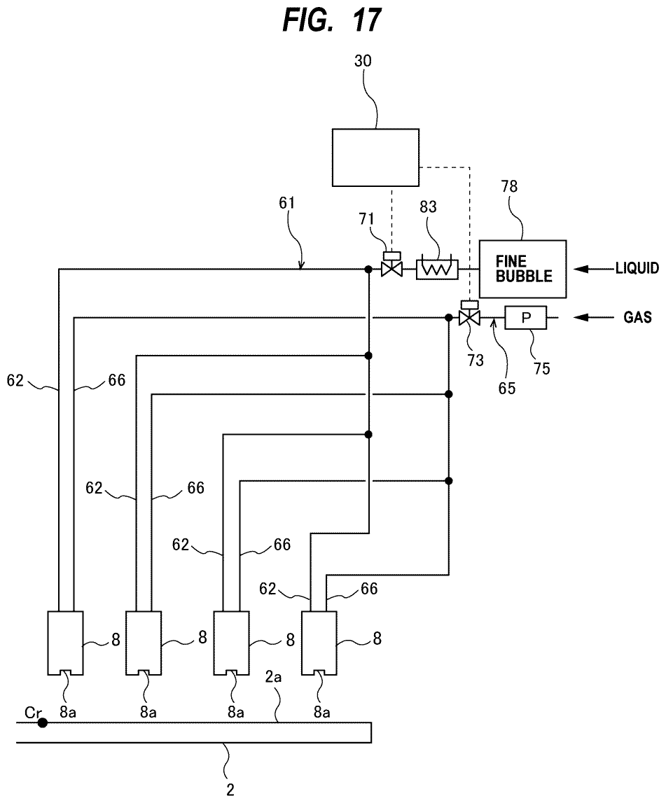

In an embodiment, as shown in FIG. 16, the fine-bubble generator 78 may be coupled to a liquid-removing fluid line 80 that supplies the liquid-removing fluid to the plurality of pad cleaning nozzles 9, instead of or in addition to the liquid supply line 61. The liquid-removing fluid line 80 is coupled to the plurality of pad cleaning nozzles 9. The liquid-removing fluid containing fine bubbles is supplied to the pad cleaning nozzles 9 through the liquid-removing fluid line 80. The pad cleaning nozzles 9 emit the jets of the liquid-removing fluid containing the fine bubbles onto the polishing pad 2. Even in this embodiment, the effect of the fine bubbles described with reference to FIGS. 14 and 15 can be obtained.

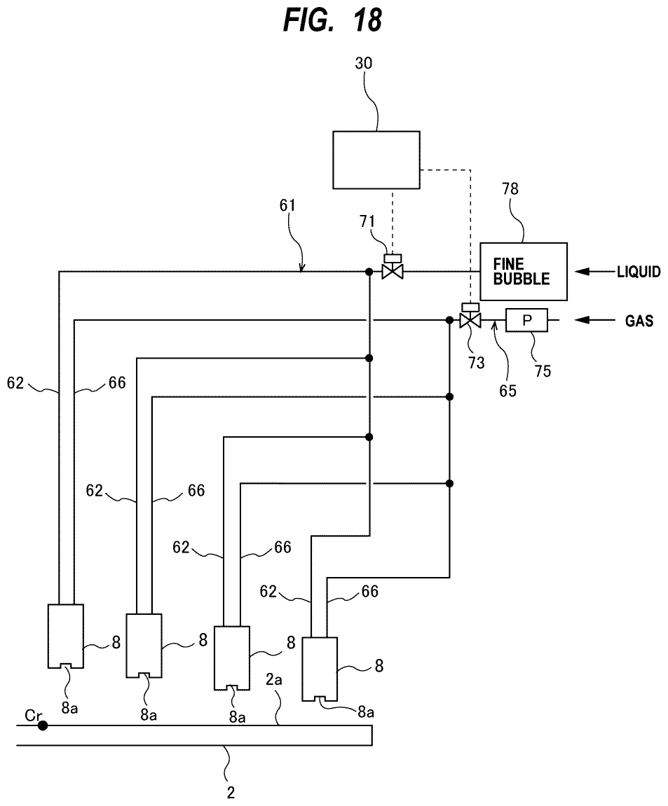

FIG. 17 is a schematic diagram showing yet another embodiment of the non-contact pad cleaning apparatus. Configurations of this embodiment that are not particularly described are the same as those of the embodiment described with reference to FIG. 13, and repetitive descriptions will be omitted. As shown in FIG. 17, the non-contact pad cleaning apparatus of this embodiment further includes a liquid heating device 83 coupled to the liquid supply line 61. The liquid heating device 83 is configured to heat the liquid flowing through the liquid supply line 61. Specifically, the liquid heating device 83 is configured to heat the liquid flowing through the liquid supply line 61 to a temperature within a range of 20° C. to 100° C. Specific configuration of the liquid heating device 83 is not particularly limited, and for example, an electric heater or the like can be used for the liquid heating device 83.

The heated liquid is supplied to the two-fluid nozzles 8 through the liquid supply line 61. The two-fluid nozzles 8 emit the two-fluid jets containing the heated liquid onto the polishing pad 2. The temperature of the polishing pad 2 is increased by the heated liquid, and the polishing pad 2 becomes soft. As a result, the two-fluid jets easily remove the foreign matter from the holes formed in the polishing pad 2. The liquid heating device 83 is applicable to each of the embodiments described with reference to FIGS. 1 to 16.

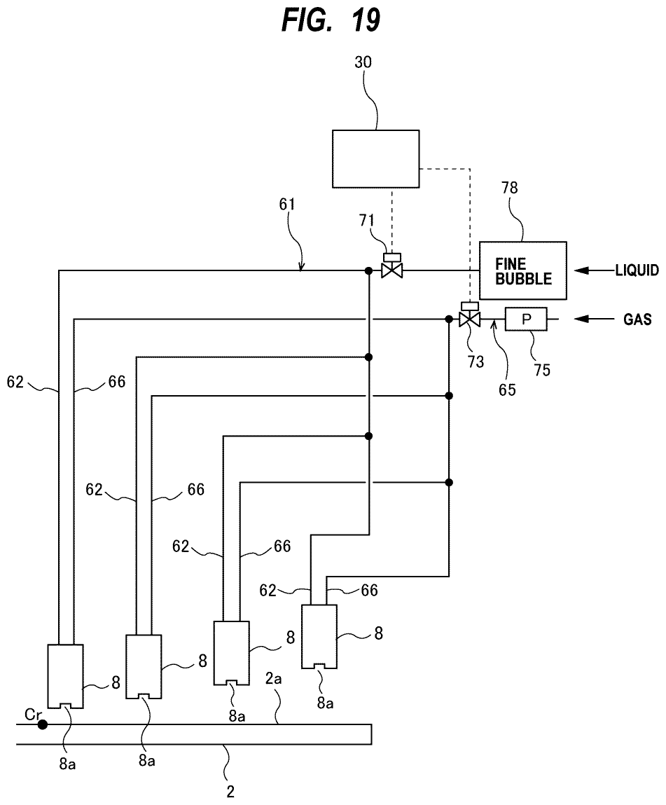

FIG. 18 is a schematic diagram showing yet another embodiment of the non-contact pad cleaning apparatus. Configurations of this embodiment that are not particularly described are the same as those of the embodiment described with reference to FIG. 13, and repetitive descriptions will be omitted. As shown in FIG. 18, a distance from the polishing surface 2a to the outlet port 8a of the two-fluid nozzle 8 located at a periphery side of the polishing pad 2 is smaller than a distance from the polishing surface 2a to the outlet port 8a of the two-fluid nozzle 8 located at a center side of the polishing pad 2. This is due to the following reason. A circumferential length on the polishing surface 2a of the polishing pad 2 increases according to a distance from the center Cr of the polishing pad 2. Therefore, the two-fluid nozzle 8 located at the periphery side of the polishing pad 2 requires a higher cleaning capability than that of the two-fluid nozzle 8 located at the center side of the polishing pad 2.

According to this embodiment, the outlet port 8a of the two-fluid nozzle 8 located at the periphery side of the polishing pad 2 is arranged closer to the polishing surface 2a, so that the cleaning effect on the peripheral region of the polishing surface 2a of the polishing pad 2 can be improved. In an embodiment, as shown in FIG. 18, the distances of the outlet ports 8a of the multiple two-fluid nozzles 8 from the polishing surface 2a may decrease according to the distance of each two-fluid nozzle 8 from the center Cr of the polishing pad 2. The two-fluid nozzles 8 arranged in this manner can uniformly clean the entire polishing surface 2a of the polishing pad 2. The arrangement of the two-fluid nozzles 8 described with reference to FIG. 18 can be applied to each of the embodiments described with reference to FIGS. 1 to 17.

In another embodiment, as shown in FIG. 19, the distance from the polishing surface 2a to the outlet port 8a of the two-fluid nozzle 8 located at the periphery side of the polishing pad 2 is larger than the distance from the polishing surface 2a to the outlet port 8a of the two-fluid nozzle 8 located at the center side of the polishing pad 2. This is for the following reason. An area to be cleaned is larger at the periphery side of the polishing surface 2a of the polishing pad 2 than that at the center side of the polishing pad 2. Since the outlet port 8a of the two-fluid nozzle 8 located at the periphery side of the polishing pad 2 is farther from the polishing surface 2a, the two-fluid jet spreads along its traveling direction, and a wider area can be cleaned with the two-fluid jet.

In an embodiment, as shown in FIG. 19, the distances of the outlet ports 8a of the multiple two-fluid nozzles 8 from the polishing surface 2a may increase with the distance of each two-fluid nozzle 8 from the center Cr of the polishing pad 2. The arrangement of the two-fluid nozzles 8 described with reference to FIG. 19 is applicable to each of the embodiments described with reference to FIGS. 1 to 17.

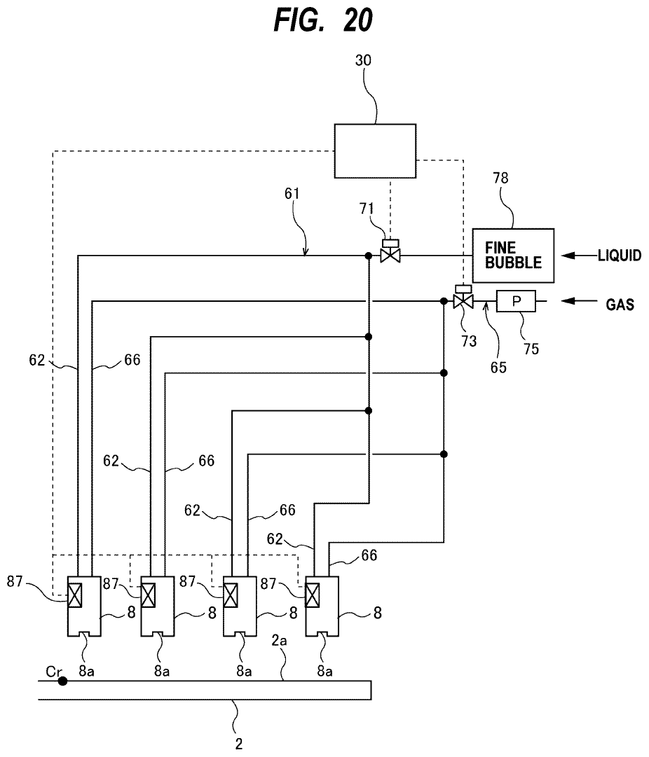

FIG. 20 is a schematic diagram showing yet another embodiment of the non-contact pad cleaning apparatus. Configurations of this embodiment that are not particularly described are the same as those of the embodiment described with reference to FIG. 13, and repetitive descriptions will be omitted. As shown in FIG. 20, the non-contact pad cleaning apparatus further includes a plurality of ultrasonic generators 87 attached to the plurality of two-fluid nozzles 8, respectively. These ultrasonic generators 87 are electrically coupled to the operation controller 30, and operations of the ultrasonic generators 87 are controlled by the operation controller 30.

The ultrasonic generators 87 are configured to apply ultrasonic waves to the two-fluid jets to be discharged from the two-fluid nozzles 8. Frequency of the ultrasonic waves is selected from a range of 100 kHz to 3.0 MHz. The operation controller 30 instructs each ultrasonic generator 87 to generate the ultrasonic waves of a preselected frequency. The ultrasonic generators 87 may generate the ultrasonic waves of the same frequency or different frequencies.

In an embodiment, the operation controller 30 controls the operations of the multiple ultrasonic generators 87 such that the frequency of the ultrasonic waves applied to the two-fluid jet to be discharged from the two-fluid nozzle 8 arranged at the periphery side of the polishing pad 2 is lower than the frequency of the ultrasonic waves applied to the two-fluid jet to be discharged from the two-fluid nozzle 8 arranged at the center side of the polishing pad 2. In general, the cleaning performance of the two-fluid jet improves as the frequency of the ultrasonic waves applied to the two-fluid jet decreases. According to this embodiment, the cleaning effect on the peripheral region of the polishing surface 2a of the polishing pad 2 can be improved.

In an embodiment, the operation controller 30 controls the operations of the multiple ultrasonic generators 87 such that the frequencies of the ultrasonic waves applied to the two-fluid jets emitted from the multiple two-fluid nozzles 8 decrease according to the distance from the center Cr of the polishing pad 2 to each two-fluid nozzle 8. The two-fluid nozzles 8 incorporating the ultrasonic generators 87 controlled in this manner can uniformly clean the entire polishing surface 2a of the polishing pad 2.

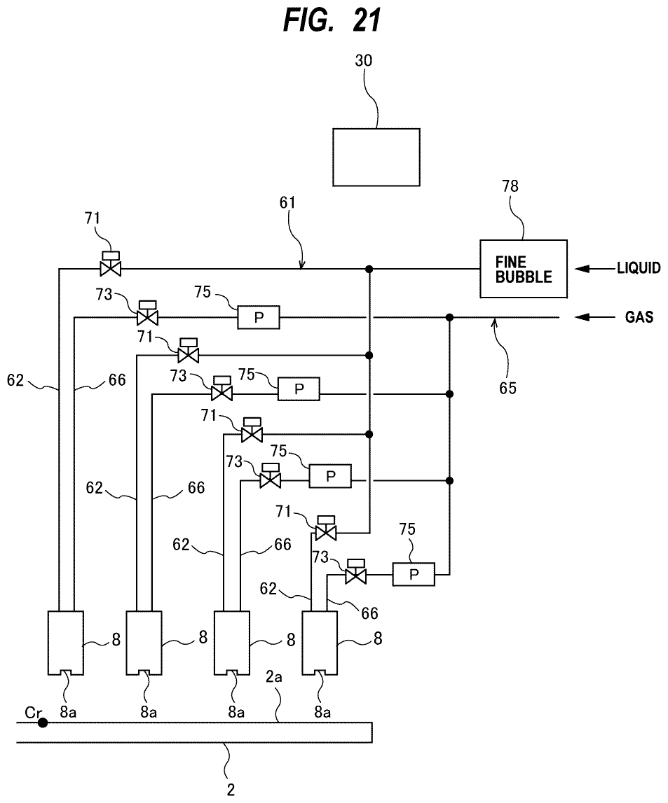

FIG. 21 is a schematic diagram showing yet another embodiment of the non-contact pad cleaning apparatus. Configurations of this embodiment that are not particularly described are the same as those of the embodiment described with reference to FIG. 15, and repetitive descriptions will be omitted. The non-contact pad cleaning apparatus includes a plurality of liquid flow-rate control valves 71 coupled to the plurality of branch liquid lines 62, a plurality of gas flow-rate control valves 73 coupled to the plurality of branch gas lines 66, and a plurality of pressure regulators 75 coupled to the plurality of branch gas lines 66.

The liquid flow-rate control valves 71 are coupled to the two-fluid nozzles 8 via the liquid supply line 61. The gas flow-rate control valves 73 are coupled to the two-fluid nozzles 8 via the gas supply line 65. The pressure regulators 75 are also coupled to the two-fluid nozzles 8 via the gas supply line 65.

The liquid flow-rate control valves 71 can independently regulate the flow rates of the liquid supplied to the two-fluid nozzles 8. The gas flow-rate control valves 73 can independently regulate the flow rates of the gas supplied to the two-fluid nozzles 8. The pressure regulators 75 can independently regulate the pressures of the gas supplied to the two-fluid nozzles 8. The liquid flow-rate control valves 71, the gas flow-rate control valves 73, and the pressure regulators 75 are electrically coupled to the operation controller 30, and the operations of the liquid flow-rate control valves 71, the gas flow-rate control valves 73, and the pressure regulators 75 are controlled by the operation controller 30. The fine-bubble generator 78 is disposed upstream of the liquid flow-rate control valves 71.

In an embodiment, the operation controller 30 controls the operations of the liquid flow-rate control valves 71 such that the flow rate of liquid supplied to the two-fluid nozzle 8 arranged at the periphery side of the polishing pad 2 is higher than the flow rate of liquid supplied to the two-fluid nozzle 8 arranged at the center side of the polishing pad 2. The two-fluid nozzle 8 arranged at the periphery side of the polishing pad 2 can apply a stronger two-fluid jet to the periphery side of the polishing surface 2a of the polishing pad 2 compared to the two-fluid nozzle 8 arranged at the center side of the polishing pad 2. According to this embodiment, the cleaning effect on the peripheral region of the polishing surface 2a of the polishing pad 2 can be improved.

In an embodiment, the operation controller 30 controls the operations of the liquid flow-rate control valves 71 such that the flow rates of the liquid supplied to the two-fluid nozzles 8 increase according to the distance of each two-fluid nozzle 8 from the center Cr of the polishing pad 2. By controlling the flow rates of the liquid in this manner, the two-fluid nozzles 8 can uniformly clean the entire polishing surface 2a of the polishing pad 2.

In another embodiment, the operation controller 30 controls the operations of the liquid flow-rate control valves 71 such that the flow rate of liquid supplied to the two-fluid nozzle 8 arranged at the center side of the polishing pad 2 is higher than the flow rate of liquid supplied to the two-fluid nozzle 8 arranged at the periphery side of the polishing pad 2. The slurry adhering to the center of the polishing pad 2 should be moved a longer distance to the outside of the polishing pad 2 than the slurry adhering to the periphery side of the polishing pad 2. Therefore, in this embodiment, in order to improve the dischargeability of the liquid at the center side of the polishing pad 2, the flow rate of liquid from the two-fluid nozzle 8 at the center side of the polishing pad 2 is higher than the flow rate of liquid from the two-fluid nozzle 8 at the periphery side of the polishing pad 2.

In an embodiment, the operation controller 30 controls the operations of the liquid flow-rate control valves 71 such that the flow rates of liquid supplied to the two-fluid nozzles 8 decrease according to the distance of each two-fluid nozzle 8 from the center Cr of the polishing pad 2.

In an embodiment, the operation controller 30 controls the operations of the gas flow-rate control valves 73 such that the flow rate of gas supplied to the two-fluid nozzle 8 arranged at the periphery side of the polishing pad 2 is higher than the flow rate of gas supplied to the two-fluid nozzle 8 arranged at the center side of the polishing pad 2. The two-fluid nozzle 8 arranged at the periphery side of the polishing pad 2 can apply a stronger two-fluid jet to the peripheral region of the polishing surface 2a of the polishing pad 2 compared to the two-fluid nozzle 8 arranged at the center side of the polishing pad 2. According to this embodiment, the cleaning effect on the peripheral region of the polishing surface 2a of the polishing pad 2 can be improved.

In an embodiment, the operation controller 30 controls the operations of the gas flow-rate control valves 73 such that the flow rates of the gas supplied to the two-fluid nozzles 8 increase according to the distance of each two-fluid nozzle 8 from the center Cr of the polishing pad 2. By controlling the flow rates of the gas in this manner, the two-fluid nozzles 8 can uniformly clean the entire polishing surface 2a of the polishing pad 2.

In another embodiment, the operation controller 30 controls the operations of the gas flow-rate control valves 73 such that the flow rate of gas supplied to the two-fluid nozzle 8 arranged at the center side of the polishing pad 2 is higher than the flow rate of gas supplied to the two-fluid nozzle 8 arranged at the periphery side of the polishing pad 2. The slurry adhering to the center of the polishing pad 2 should be moved a longer distance to the outside of the polishing pad 2 than the slurry adhering to the periphery side of the polishing pad 2. Therefore, in this embodiment, in order to improve the dischargeability of the liquid at the center side of the polishing pad 2, the flow rate of gas from the two-fluid nozzle 8 at the center side of the polishing pad 2 is higher than the flow rate of gas from the two-fluid nozzle 8 at the periphery side of the polishing pad 2.

In an embodiment, the operation controller 30 controls the operations of the gas flow-rate control valves 73 such that the flow rates of gas supplied to the two-fluid nozzles 8 decrease according to the distance of each two-fluid nozzle 8 from the center Cr of the polishing pad 2.

In an embodiment, the operation controller 30 controls the operations of the pressure regulators 75 such that the pressure of the gas supplied to the two-fluid nozzle 8 arranged at the periphery side of the polishing pad 2 is higher than the pressure of the gas supplied to the two-fluid nozzle 8 arranged at the center side of the polishing pad 2. The two-fluid nozzle 8 arranged at the periphery side of the polishing pad 2 can apply a stronger two-fluid jet to the peripheral region of the polishing surface 2a of the polishing pad 2 compared to the two-fluid nozzle 8 arranged at the center side of the polishing pad 2. According to this embodiment, the cleaning effect on the peripheral region of the polishing surface 2a of the polishing pad 2 can be improved.

In an embodiment, the operation controller 30 controls the operations of the pressure regulators 75 such that the pressures of the gas supplied to the two-fluid nozzles 8 increase according to the distance of each two-fluid nozzle 8 from the center Cr of the polishing pad 2. By controlling the gas pressures in this manner, the two-fluid nozzles 8 can uniformly clean the entire polishing surface 2a of the polishing pad 2.

The arrangement of the multiple liquid flow-rate control valves 71, the arrangement of the multiple gas flow-rate control valves 73, and the arrangement of the multiple pressure regulators 75 described with reference to FIG. 21 are applicable to each of the embodiments described with reference to FIGS. 1 to 20.

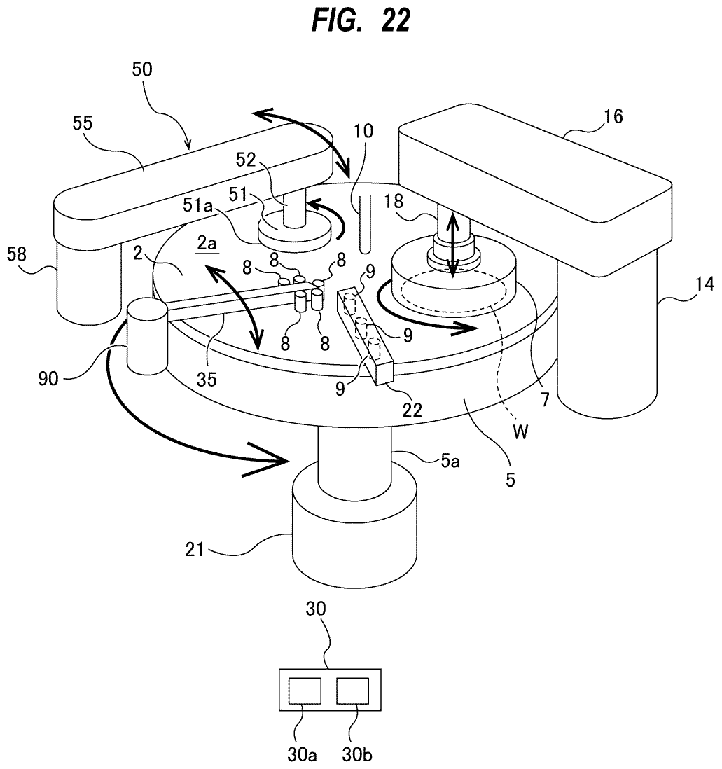

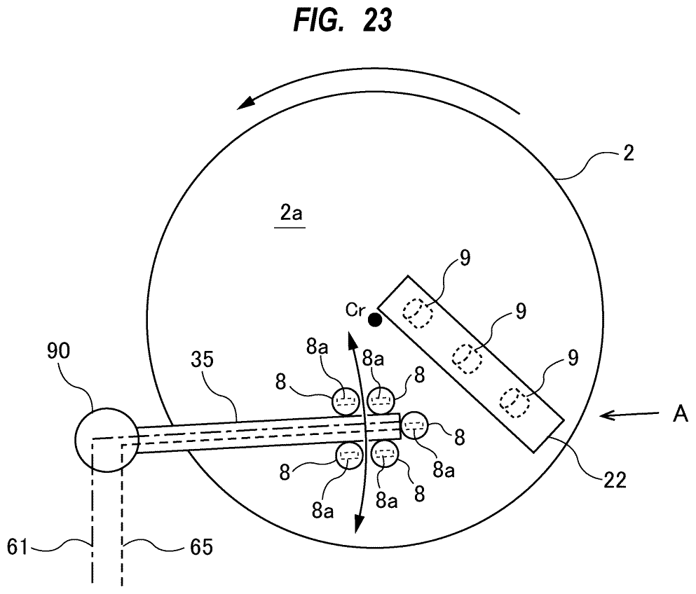

FIG. 22 is a schematic diagram showing yet another embodiment of the non-contact pad cleaning apparatus, and FIG. 23 is a top view of the two-fluid liquid nozzles 8 and the pad cleaning nozzles 9 shown in FIG. 22. Configurations of this embodiment that are not particularly described are the same as those of the embodiment described with reference to FIG. 1, and repetitive descriptions will be omitted. The non-contact pad cleaning apparatus includes a nozzle oscillation mechanism 90 configured to oscillate the two-fluid nozzles 8 along the polishing surface 2a. The two-fluid nozzles 8 are held by nozzle holder 35. The two-fluid nozzles 8 are coupled to the liquid supply line 61 and the gas supply line 65. The pad cleaning nozzles 9 are disposed downstream of the two-fluid nozzles 8 in the rotation direction of the polishing pad 2.

The nozzle oscillation mechanism 90 is configured to oscillate the two-fluid nozzles 8 in the radial direction of the polishing pad 2 by oscillating the nozzle holder 35. The nozzle oscillation mechanism 90 is configured to be able to change an oscillation speed of the two-fluid nozzles 8. In an embodiment, the nozzle oscillation mechanism 90 is configured to oscillate the two-fluid nozzles 8 in the radial direction of the polishing pad 2 by alternately rotating the nozzle holder 35 by a predetermined angle in the clockwise and counterclockwise directions about an end portion of the nozzle holder 35. In another embodiment, the nozzle oscillation mechanism 90 may be configured to oscillate the two-fluid nozzles 8 in the radial direction of the polishing pad 2 by translating the nozzle holder 35.

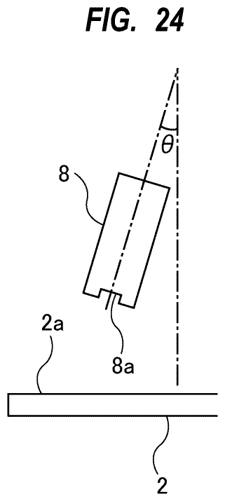

FIG. 24 is a view of the two-fluid nozzle 8 as viewed from a direction indicated by arrow A in FIG. 22. The outlet port 8a of each two-fluid nozzle 8 faces outward in the radial direction of the polishing pad 2. The inclination angle θ of each two-fluid nozzle 8 with respect to the direction perpendicular to the polishing surface 2a is larger than 0 degrees and equal to or less than 60 degrees. More preferably, the inclination angle θ of each two-fluid nozzle 8 is within a range of 15 to 30 degrees. The two-fluid nozzles 8 may be inclined at different angles with respect to the polishing surface 2a.

Since the outlet ports 8a of the two-fluid nozzles 8 face outward in the radial direction of the polishing pad 2, the two-fluid jets discharged from the outlet ports 8a form an outward flow of liquid on the polishing surface 2a. This outward flow of liquid is accelerated by the centrifugal force generated by the rotating polishing pad 2, and can wash away the foreign matter, such as polishing debris, from the polishing pad 2.

The arrangement of the two-fluid nozzles 8 is not limited to the embodiment described with reference to FIGS. 22 to 24. In an embodiment, the plurality of two-fluid nozzles 8 may be linearly arranged. In the embodiment described with reference to FIGS. 22 to 24, five two-fluid nozzles 8 are provided, while the number of two-fluid nozzles 8 is not limited to the above embodiment. In an embodiment, a single two-fluid nozzle 8 may be provided.

The embodiments described with reference to FIGS. 1 to 24 may be appropriately combined. The configurations of the embodiments described with reference to FIGS. 1 to 21, such as the fine-bubble generator 78, the ultrasonic generator 87, the liquid heating device 83, and the inclination of the two-fluid nozzle 8 with respect to the polishing surface 2a, may be applied to the embodiments described with reference to FIGS. 22 to 24.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A non-contact pad cleaning apparatus for cleaning a polishing surface of a polishing pad in a non-contact manner, the polishing pad being used for polishing a workpiece, comprising:
a turntable configured to rotate the polishing pad;
a plurality of two-fluid nozzles disposed above the polishing pad; and
a liquid supply line and a gas supply line coupled to the plurality of two-fluid nozzles,
wherein the plurality of two-fluid nozzles are arranged along a radial direction of the polishing pad, and
the plurality of two-fluid nozzles have outlet ports which are inclined obliquely with respect to a reference line extending in the radial direction of the polishing pad when viewed from a direction perpendicular to the polishing surface of the polishing pad.

2. The non-contact pad cleaning apparatus according to claim 1, wherein the outlet ports of the plurality of two-fluid nozzles are inclined in the same direction as the rotation direction of the polishing pad when viewed from the direction perpendicular to the polishing surface of the polishing pad.

3. The non-contact pad cleaning apparatus according to claim 1, wherein the outlet ports of the plurality of two-fluid nozzles are located on the reference line when viewed from the direction perpendicular to the polishing surface of the polishing pad.

4. The non-contact pad cleaning apparatus according to claim 1, wherein inclination angles of the outlet ports of the plurality of two-fluid nozzles with respect to the reference line when viewed from the direction perpendicular to the polishing surface of the polishing pad increase according to a distance of each two-fluid nozzle from a center of the polishing pad.

5. The non-contact pad cleaning apparatus according to claim 4, wherein distances of the outlet ports of the plurality of two-fluid nozzles from the reference line when viewed from the direction perpendicular to the polishing surface of the polishing pad increase according to the distance of each two-fluid nozzle from the center of the polishing pad, and
the distances of the outlet ports of the plurality of two-fluid nozzles from the reference line are distances from the reference line toward a downstream side in a rotation direction of the polishing pad.

6. The non-contact pad cleaning apparatus according to claim 1, further comprising a fine-bubble generator coupled to the liquid supply line.

7. The non-contact pad cleaning apparatus according to claim 1, further comprising a liquid heating device coupled to the liquid supply line and configured to heat liquid flowing through the liquid supply line.

8. The non-contact pad cleaning apparatus according to claim 1, wherein the plurality of two-fluid nozzles include a center-side two-fluid nozzle located at a center side of the polishing pad and a periphery-side two-fluid nozzle located at a periphery side of the polishing pad, and
a distance of an outlet port of the periphery-side two-fluid nozzle from the polishing surface is smaller than a distance of an outlet port of the center-side two-fluid nozzle from the polishing surface.

9. The non-contact pad cleaning apparatus according to claim 1, wherein the plurality of two-fluid nozzles include a center-side two-fluid nozzle located at a center side of the polishing pad and a periphery-side two-fluid nozzle located at a periphery side of the polishing pad, and
a distance of an outlet port of the periphery-side two-fluid nozzle from the polishing surface is larger than a distance of an outlet port of the center-side two-fluid nozzle from the polishing surface.

10. The non-contact pad cleaning apparatus according to claim 1, wherein
the liquid supply line has a plurality of branch liquid lines coupled to the plurality of two-fluid nozzles, respectively,
the non-contact pad cleaning apparatus further comprises a plurality of liquid flow-rate control valves coupled to the plurality of branch liquid lines, respectively, and an operation controller configured to independently control operations of the plurality of liquid flow-rate control valves,
the plurality of two-fluid nozzles include a center-side two-fluid nozzle located at a center side of the polishing pad and a periphery-side two-fluid nozzle located at a periphery side of the polishing pad, and
the operation controller is configured to control the operations of the plurality of liquid flow-rate control valves such that a flow rate of liquid supplied to the periphery-side two-fluid nozzle is higher than a flow rate of liquid supplied to the center-side two-fluid nozzle.

11. The non-contact pad cleaning apparatus according to claim 1, wherein
the liquid supply line has a plurality of branch liquid lines coupled to the plurality of two-fluid nozzles, respectively,
the non-contact pad cleaning apparatus further comprises a plurality of liquid flow-rate control valves coupled to the plurality of branch liquid lines, respectively, and an operation controller configured to independently control operations of the plurality of liquid flow-rate control valves,
the plurality of two-fluid nozzles include a center-side two-fluid nozzle located at a center side of the polishing pad and a periphery-side two-fluid nozzle located at a periphery side of the polishing pad, and
the operation controller is configured to control the operations of the plurality of liquid flow-rate control valves such that a flow rate of liquid supplied to the center-side two-fluid nozzle is higher than a flow rate of liquid supplied to the periphery-side two-fluid nozzle.

12. The non-contact pad cleaning apparatus according to claim 1, wherein
the gas supply line has a plurality of branch gas lines coupled to the plurality of two-fluid nozzles, respectively,
the non-contact pad cleaning apparatus further comprises a plurality of gas flow-rate control valves coupled to the plurality of branch gas lines, respectively, and an operation controller configured to independently control operations of the plurality of gas flow-rate control valves,
the plurality of two-fluid nozzles include a center-side two-fluid nozzle located at a center side of the polishing pad and a periphery-side two-fluid nozzle located at a periphery side of the polishing pad, and
the operation controller is configured to control the operations of the plurality of gas flow-rate control valves such that a flow rate of gas supplied to the periphery-side two-fluid nozzle is higher than a flow rate of gas supplied to the center-side two-fluid nozzle.

13. The non-contact pad cleaning apparatus according to claim 1, wherein
the gas supply line has a plurality of branch gas lines coupled to the plurality of two-fluid nozzles, respectively,
the non-contact pad cleaning apparatus further comprises a plurality of gas flow-rate control valves coupled to the plurality of branch gas lines, respectively, and an operation controller configured to independently control operations of the plurality of gas flow-rate control valves,
the plurality of two-fluid nozzles include a center-side two-fluid nozzle located at a center side of the polishing pad and a periphery-side two-fluid nozzle located at a periphery side of the polishing pad, and
the operation controller is configured to control the operations of the plurality of gas flow-rate control valves such that a flow rate of gas supplied to the center-side two-fluid nozzle is higher than a flow rate of gas supplied to the periphery-side two-fluid nozzle.

14. The non-contact pad cleaning apparatus according to claim 1, wherein
the gas supply line has a plurality of branch gas lines coupled to the plurality of two-fluid nozzles, respectively,
the non-contact pad cleaning apparatus further comprises a plurality of pressure regulators coupled to the plurality of branch gas lines, respectively, and an operation controller configured to independently control operations of the plurality of pressure regulators,
the plurality of two-fluid nozzles include a center-side two-fluid nozzle located at a center side of the polishing pad and a periphery-side two-fluid nozzle located at a periphery side of the polishing pad, and
the operation controller is configured to control the operations of the plurality of pressure regulators such that a pressure of gas supplied to the periphery-side two-fluid nozzle is higher than a pressure of gas supplied to the center-side two-fluid nozzle.

15. A non-contact pad cleaning apparatus for cleaning a polishing surface of a polishing pad in a non-contact manner, the polishing pad being used for polishing a workpiece, comprising:
a turntable configured to rotate the polishing pad;
a two-fluid nozzle disposed above the polishing pad, the two-fluid nozzle having an outlet port facing outward in a radial direction of the polishing pad;
a liquid supply line and a gas supply line coupled to the two-fluid nozzle; and
a nozzle oscillation mechanism configured to oscillate the two-fluid nozzle along the polishing surface.

16. The non-contact pad cleaning apparatus according to claim 15, further comprising a fine-bubble generator coupled to the liquid supply line.

17. The non-contact pad cleaning apparatus according to claim 15, further comprising a liquid heating device coupled to the liquid supply line and configured to heat liquid flowing through the liquid supply line.
